(19) United States
(12) Patent Application Publication
(10) Pub. No.: US 2015/0370064 A1
(43) Pub. Date: Dec. 24, 2015

(54) DISPLAY DEVICE

(71) Applicant: SHARP KABUSHIKI KAISHA, Abeno-ku, Osaka (JP)

(72) Inventor: Makoto EGUCHI, Osaka (JP)

(73) Assignee: Sharp Kabushiki Kaisha, Osaka (JP)

(21) Appl. No.: 14/758,713

(22) PCT Filed: Dec. 24, 2013
(86) PCT No.: PCT/JP2013/084517

§ 371 Date: Jun. 30, 2015

(30) Foreign Application Priority Data
Jan. 8, 2013 (JP) 2013-001262

(51) Int. Cl. G02B 26/08; G02B 26/00; G02B 3/00

(52) U.S. Cl. CPC G02B 26/0875; G02B 3/0037; G02B 26/005

(57) ABSTRACT

The present invention provides a display device that can increase the apparent number of pixels. The display device includes a display panel and an optical path changing device. The optical path changing device includes a first lens and an optical path controller between the display panel and the first lens to control optical paths of respective light rays from the plurality of pixels in the display panel. The first lens has a light receiving inner surface having a plurality of inner lens surfaces and a light exit outer surface having a plurality of outer lens surfaces. The inner lens surfaces and the outer lens surfaces of the first lens are configured such that light from the display panel that has entered a prescribed portion of the inner lens surfaces exits one outer lens surface in a prescribed incident angle exits from a corresponding one of the outer lens surfaces to reach the viewer.

### TECHNICAL FIELD

The present invention relates to a display device, and more particularly to a display device provided with an optical path changing device that changes the paths taken by light emitted from pixels formed in a display panel.

### BACKGROUND ART

In recent years, display devices have been designed to feature increasingly high resolutions. As the pursuit of ever higher resolutions continues, the number of pixels used in display panels increases accordingly. As the number of pixels in display panels increases, components such as the pixel electrodes and wiring lines must be patterned with increasingly high precision. This increases the difficulty of patterning these components such as pixel electrodes and wiring lines.

Moreover, as this pursuit of increasingly high resolutions continues, pixel aperture ratios become increasingly small. In liquid crystal display devices, smaller pixel aperture ratios make it more difficult for light from the backlight to pass through the display panel. As a result, the brightness of the light from the backlight must be increased. This means that as liquid crystal display devices continue to be designed with higher resolutions, power consumption continues to increase accordingly.

### SUMMARY OF THE INVENTION

An object of the present invention is to provide a display device that can increase the apparent number of pixels.

A display device according to one embodiment of the present invention includes: a display panel including a plurality of pixels formed side by side in a prescribed direction; and an optical path changing device that is arranged closer to a viewer's side than the display panel and that changes paths taken by light emitted from the pixels, wherein the optical path changing device includes: a first lens; a plurality of second lenses arranged side by side in the prescribed direction and disposed closer to the display panel than the first lens; and an emission direction control device that changes a direction in which light from the pixels that has entered the second lenses is emitted therefrom, wherein the first lens includes: a plurality of inner lens surfaces formed side by side in the prescribed direction on a display panel side; and pairs of outer lens surfaces that are formed side by side in the prescribed direction on the viewer's side, overlapping each of the inner lens surfaces when the display panel is viewed from a front side, wherein light from the pixels that has entered the inner lens surface exits one of the outer lens surfaces among the respective pairs of outer lens surfaces in accordance with a direction in which the light from the pixels that has entered the second lenses is emitted therefrom.

The display device according to an embodiment of the present invention can increase the apparent number of pixels.

### BRIEF DESCRIPTION OF THE DRAWINGS

FIG. 1 schematically illustrates an example configuration of a display device according to Embodiment 1 of the present invention.

FIG. 2 is a plan view illustrating an optical path changing device of the display device shown in FIG. 1.

FIG. 3A schematically illustrates the paths taken by light emitted from pixels.

FIG. 3B schematically illustrates the paths taken by light emitted from pixels when the light takes different paths than those shown in FIG. 3A.

FIG. 4 schematically illustrates another mechanism used to move a second lens.

FIG. 5 schematically illustrates an example configuration of a display device according to Embodiment 2 of the present invention.

FIG. 6 is a plan view illustrating an optical path changing device of the display device shown in FIG. 5.

FIG. 7A schematically illustrates the paths taken by light emitted from pixels.

FIG. 7B schematically illustrates the paths taken by light emitted from pixels when the light takes different paths than those shown in FIG. 7A.

FIG. 8 schematically illustrates an example configuration of a display device according to Embodiment 3 of the present invention.

FIG. 9 is an enlarged cross-sectional view of a portion of FIG. 8.

### DETAILED DESCRIPTION OF EMBODIMENTS

A display device according to one embodiment of the present invention includes: a display panel including a plurality of pixels formed side by side in a prescribed direction; and an optical path changing device that is arranged closer to a viewer's side than the display panel and that changes paths taken by light emitted from the pixels, wherein the optical path changing device includes: a first lens; a plurality of second lenses arranged side by side in the prescribed direction and disposed closer to the display panel than the first lens; and an emission direction control device that changes a direction in which light from the pixels that has entered the second lenses is emitted therefrom, wherein the first lens includes: a plurality of inner lens surfaces formed side by side in the prescribed direction on a display panel side; and pairs of outer lens surfaces that are formed side by side in the prescribed direction on the viewer's side, overlapping each of the inner lens surfaces when the display panel is viewed from a front side, wherein light from the pixels that has entered the inner lens surface exits one of the outer lens surfaces among the respective pairs of outer lens surfaces in accordance with a direction in which the light from the pixels that has entered the second lenses is emitted therefrom.

In a first configuration of an embodiment of the present invention, the light from pixels that enters the inner lens surfaces exits one outer lens surface of each pair of outer lens surfaces according to the direction in which the light from the pixels that enters the second lenses is emitted therefrom. As a result, this configuration can increase the apparent number of pixels in the prescribed direction.

In a second configuration of an embodiment of the present invention, the second lenses of the first configuration are configured to be rotatable between a first position and a second position differing from the first position, and a direction in which light from the pixels is focused when the second lenses are in the first position differs from a direction in which light from the pixels is focused when the second lenses are in the second position.

This makes it possible to change the direction in which light from the pixels that enters the second lenses is emitted therefrom.

In a third configuration of an embodiment of the present invention, the second lenses are configured so as to be moveable laterally between a first position and a second position that differs from the first position, and a direction in which light from the pixels is focused when the second lenses are in the first position differs from a direction in which light from the pixels is focused when the second lenses are in the second position.

This makes it possible to change the direction in which light from the pixels that enters the second lenses is emitted therefrom.

In a fourth configuration of an embodiment of the present invention, the second lens of the first configuration includes: a substrate facing the first lens; a plurality of trenches arranged side by side in the prescribed direction on a surface of the substrate facing the first lens; a hydrophobic dielectric film formed along inner surfaces of the trenches; electrodes that are covered by the hydrophobic dielectric film, one of the electrodes being arranged on each wall among a pair of walls of each trench; an oil film housed inside the trenches and arranged in contact with the hydrophobic dielectric film; and a liquid that covers the oil film and is separated therefrom, wherein the emission direction control device changes voltages applied to the electrodes.

The shape of the interface between the oil film and the liquid is changed by changing the voltages applied to the first electrodes. This makes it possible to change the direction in which light from the pixels that enters the second lens member is emitted therefrom.

In a fifth configuration of an embodiment of the present invention, the pixels of any one of the first to fourth configurations each include a plurality of sub-pixels that respectively emit light of different colors and that are arranged side by side in the prescribed direction, and wherein each of the outer lens surfaces among the pairs of outer lens surfaces includes a plurality of first outer lens surfaces, each of the first outer lens surfaces corresponding to one of the sub-pixels.

Next, embodiments of the present invention will be described in more detail with reference to figures. The same reference characters are used for components that are the same or equivalent in each of the figures, and duplicate descriptions of such components are omitted. Moreover, in the figures referenced below, configurations of the present invention are depicted in a simplified or schematic style for purposes of explanation. Some components are not depicted in the figures. Furthermore, the dimensional proportions depicted between the components in the figures are not necessarily the actual dimensional proportions between those components.

### Embodiment 1

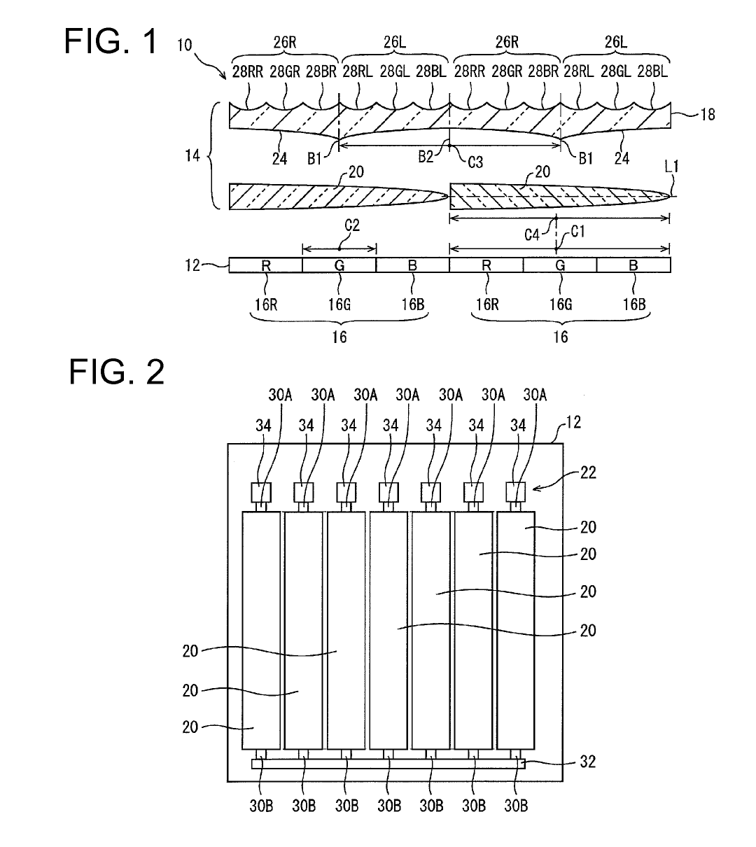

FIG. 1 shows a display device 10 according to Embodiment 1 of the present invention. The display device 10 includes a display panel 12 and an optical path changing device 14.

<Display Panel>

The display panel 12 includes a plurality of pixels 16 arranged side by side in a left-to-right direction (that is, the horizontal direction relative to the display panel 12). Each pixel 16 includes a plurality of sub-pixels 16R, 16G, and 16B. The plurality of sub-pixels 16R, 16B, and 16B are arranged side by side in the same direction in which the plurality of pixels 16 are arranged. Each sub-pixel in the plurality of sub-pixels 16R, 16G, and 16B emits light of a different color. In the present embodiment, the sub-pixel 16R emits red light, the sub-pixel 16G emits green light, and the sub-pixel 16B emits blue light.

The display panel 12 is not particularly limited in any way. The display panel 12 may be a liquid crystal panel, an organic electroluminescent panel, or a plasma display panel, for example. When the display panel 12 is a liquid crystal panel, the display device 10 also includes a backlight (not shown in the figures). In such a configuration of the display device 10, the pixels in the liquid crystal panel emit light that originates from the backlight and passes through the pixels.

<Optical Path Changing Device>

The optical path changing device 14 is arranged nearer to the viewer than the display panel 12 and changes the paths taken by light emitted from the pixels 16. The optical path changing device 14 includes a first lens 18, a plurality of second lenses 20, and an emission direction control device 22 (shown in FIG. 2).

<First Lens>

The first lens 18 has a plurality of inner lens surfaces 24 and a plurality of pairs of outer lens surfaces 26R and 26L.

The plurality of inner lens surfaces 24 are formed on the display panel 12 side of the first lens 18 and are arranged side by side in the horizontal direction. Each inner lens surface 24 is a concave lens surface that opens towards the display panel 12. When viewing the display panel 12 from the front side, the boundaries B1 between adjacent inner lens surfaces 24 are positioned directly over the centers C1 of the pixels 16 in the horizontal direction. Therefore, in the present embodiment, when viewing the display panel 12 from the front side, the boundaries B1 are positioned directly over the centers C2 of the sub-pixels 16G in the horizontal direction. The length of each inner lens surface 24 in the horizontal direction is equal to the pixel pitch.

The plurality of pairs of outer lens surfaces 26R and 26L are formed on the viewer side of the first lens 18 and are arranged side by side in the horizontal direction. When viewing the display panel 12 from the front side, each of the plurality of inner lens surfaces 24 overlaps with one pair of the outer lens surfaces 26R and 26L. In other words, the outer lens surfaces 26R and 26L are arranged alternately in the horizontal direction on the viewer side of the first lens 18.

When viewing the display panel 12 from the front side, the boundary B2 between the outer lens surface 26R and the outer lens surface 26L in one pair of outer lens surfaces 26R and 26L that overlaps with one of the inner lens surfaces 24 is positioned directly over the center C3 of that inner lens surface 24 in the horizontal direction. When viewing the display panel 12 from the front side, the boundary between one outer lens surface 26R that overlaps with one of two adjacent inner lens surfaces 24 and one outer lens surface 26L that overlaps with the other of the two adjacent inner lens surfaces 24 is positioned directly on the boundary B1.

Each outer lens surface 26R includes a plurality of first outer lens surfaces 28RR, 28GR, and 28BR that correspond to the sub-pixels 16R, 16G, and 16B, respectively, of one of the pixels 16. The plurality of first outer lens surfaces 26RR, 28GR, and 28BR are arranged side by side in the horizontal direction. The plurality of first outer lens surfaces 26RR, 28GR, and 28BR are arranged side by side in the same order in which the plurality of sub-pixels 16R, 16G, and 16B are arranged. Each of the plurality of first outer lens surfaces 26RR, 28GR, and 28BR is a concave lens surface that opens towards the viewer side.

Each outer lens surface 26L includes a plurality of first outer lens surfaces 28RL, 28GL, and 28BL that correspond to the sub-pixels 16R, 16G, and 16B, respectively, of one of the pixels 16. The plurality of first outer lens surfaces 26RL, 28GL, and 28BL are arranged side by side in the horizontal direction. The plurality of first outer lens surfaces 26RL, 28GL, and 28BL are arranged side by side in the same order in which the plurality of sub-pixels 16R, 16G, and 16B are arranged. Each of the plurality of first outer lens surfaces 26RL, 28GL, and 28BL is a concave lens surface that opens towards the viewer side.

<Second Lenses>

The plurality of second lenses 20 are arranged side by side in the horizontal direction and are nearer to the display panel 12 than is the first lens 18. In the present embodiment, there is one second lens 20 for each pixel 16. In other words, the number of second lenses 20 is the same as the number pixels 16 that are arranged side by side in the horizontal direction.

When viewing the display panel 12 from the front side, the centers C4 of each second lens 20 in the horizontal direction are positioned directly over the centers C1 of each pixel 16 in the horizontal direction and align with the boundaries B1 between adjacent inner lens surfaces 24.

Each second lens 20 is a prism-shaped member having a prescribed cross-sectional shape. The cross-sectional shape of each second lens 20 is symmetric around a reference line L1 that runs in the horizontal direction. Each second lens 20 decreases in thickness moving from one side of the horizontal direction to the other. Each second lens 20 has two convex lens surfaces (a light-entering surface into which light enters and a light-exiting surface through which light exits). As a result, light that enters each second lens 20 is concentrated in a prescribed direction (that is, towards the thicker edge of the second lens 20). The length of each second lens 20 in the horizontal direction is equal to the length of each inner lens surface 24 in the horizontal direction.

Each of the second lenses 20 is arranged having the same orientation. In other words, the thicker edge of one second lens 20 neighbors the thinner edge of the adjacent second lens 20.

<Emission Direction Control Device>

Next, the emission direction control device 22 will be described with reference to FIG. 2. The emission direction control device 22 includes a plurality of motors 34. The motors 34 are driven by a driver circuit (not shown in the figure). The driving force of each motor 34 is transmitted to an axle 30A provided on one lengthwise end of each second lens 20. This causes each second lens 20 to rotate around the centerline axis of the corresponding axle 30A. Moreover, an axle 30B is formed on the other lengthwise end of each second lens 20. The axles 30B are rotatably connected to a supporting member 32 formed on the viewer-side surface of the display panel 12.

<Operation of the Optical Path Changing Device>

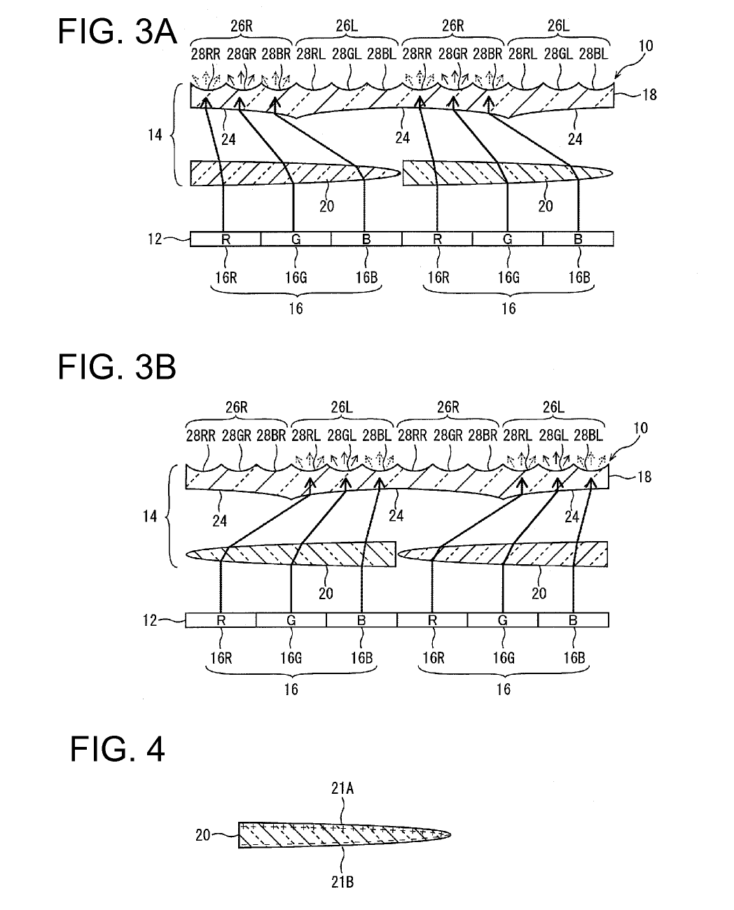

Next, operation of the optical path changing device 14 will be described with reference to FIGS. 3A and 3B. When the second lenses 20 are in the state shown in FIG. 3A, light emitted from the sub-pixels 16R, 16G, and 16B takes the paths described below.

Light emitted from the sub-pixel 16R enters the respective second lens 20 and exits proceeding towards the left inner lens surface 24 of the two inner lens surfaces 24 that overlap with that second lens 20 when the display panel 12 is viewed from the front side. The light emitted from the sub-pixel 16R then enters that inner lens surface 24 and exits from the first outer lens surface 28RR that overlaps with that inner lens surface 24 when the display panel 12 is viewed from the front side.

Light emitted from the sub-pixel 16G enters the same second lens 20 and exits proceeding towards the abovementioned left inner lens surface 24. The light emitted from the sub-pixel 16G then enters that inner lens surface 24 and exits from the first outer lens surface 28GR that overlaps with that inner lens surface 24 when the display panel 12 is viewed from the front side.

Light emitted from the sub-pixel 16B enters the same second lens 20 and exits proceeding towards the abovementioned left inner lens surface 24. The light emitted from the sub-pixel 16B then enters that inner lens surface 24 and exits from the first outer lens surface 28BR that overlaps with that inner lens surface 24 when the display panel 12 is viewed from the front side.

When the rotational force of each of the motors 34 is transmitted to the respective axles 30A, each of the second lenses 20 rotates around the centerline axis of the respective axle 30A. This rotates the second lenses 20 into the state shown in FIG. 3B. In the state shown in FIG. 3B, the second lenses 20 are rotated one half of a full rotation from the state shown in FIG. 3A. When the second lenses 20 are in the state shown in FIG. 3B, light emitted from the sub-pixels 16R, 16G, and 16B takes the paths described below.

Light emitted from the sub-pixel 16R enters the respective second lens 20 and exits proceeding towards the right inner lens surface 24 of the two inner lens surfaces 24 that overlap with that second lens 20 when the display panel 12 is viewed from the front side. The light emitted from the sub-pixel 16R then enters that inner lens surface 24 and exits from the first outer lens surface 28RL that overlaps with that inner lens surface 24 when the display panel 12 is viewed from the front side.

Light emitted from the sub-pixel 16G enters the same second lens 20 and exits proceeding towards the abovementioned right inner lens surface 24. The light emitted from the sub-pixel 16G then enters that inner lens surface 24 and exits from the first outer lens surface 28GL that overlaps with that inner lens surface 24 when the display panel 12 is viewed from the front side.

Light emitted from the sub-pixel 16B enters the same second lens 20 and exits proceeding towards the abovementioned right inner lens surface 24. The light emitted from the sub-pixel 16B then enters that right inner lens surface 24 and exits from the first outer lens surface 28BL that overlaps with that inner lens surface 24 when the display panel 12 is viewed from the front side.

As described above, as the second lenses 20 are rotated, the light emitted from the sub-pixels 16R, 16G, and 16B exits alternately from the outer lens surfaces 26R and the outer lens surfaces 26L. Therefore, by switching the image displayed by the display panel 12 back and forth between an image formed from light emitted from the outer lens surfaces 26R and an image formed from light emitted from the outer lens surfaces 26L, the apparent number of pixels that the user perceives in the horizontal direction can be increased by a factor of two.

It should be noted that the timing with which each second lens 20 is rotated by half of a full rotation and the timing with which the image displayed by the display panel 12 is switched must be synchronized. Moreover, all of the second lenses 20 must be rotated by half of a full rotation at the same time.

Furthermore, light emitted from the pixels 16 is not separated into individual colors in the display device 10, thereby reducing the occurrence of color breaking effects.

<Example Driving Method for the Second Lenses>

As shown in FIG. 4, each second lens 20 has two lens surfaces 21A and 21B. One lens surface is positively charged, and the other lens surface is negatively charged, for example. The second lenses 20 are then arranged between a pair of electrodes (not shown in the figure). The polarity of the charge applied to each electrode is then changed to create repulsive forces between the electrodes and the second lenses 20. These repulsive forces cause the second lenses 20 to rotate. The second lenses 20 may be driven using this driving method.

### Embodiment 2

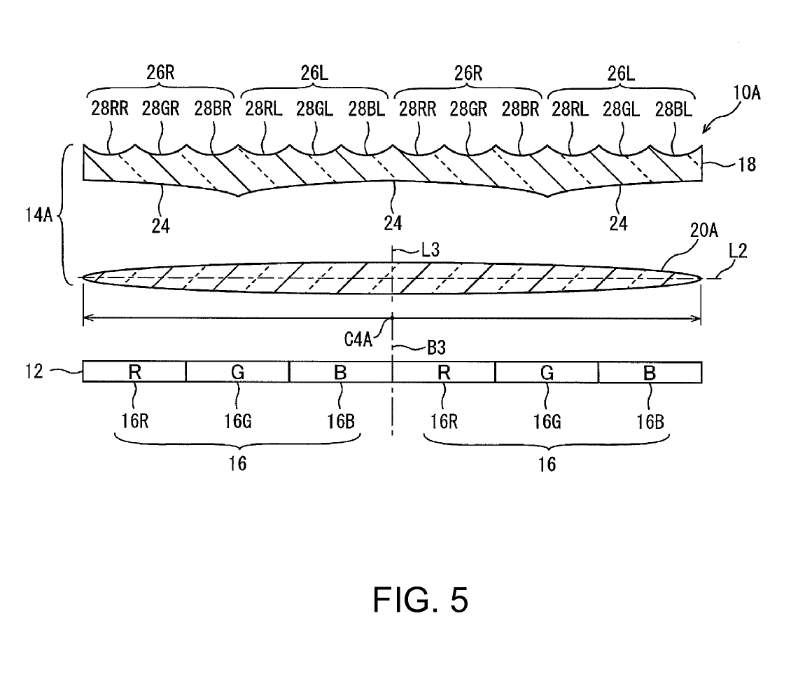

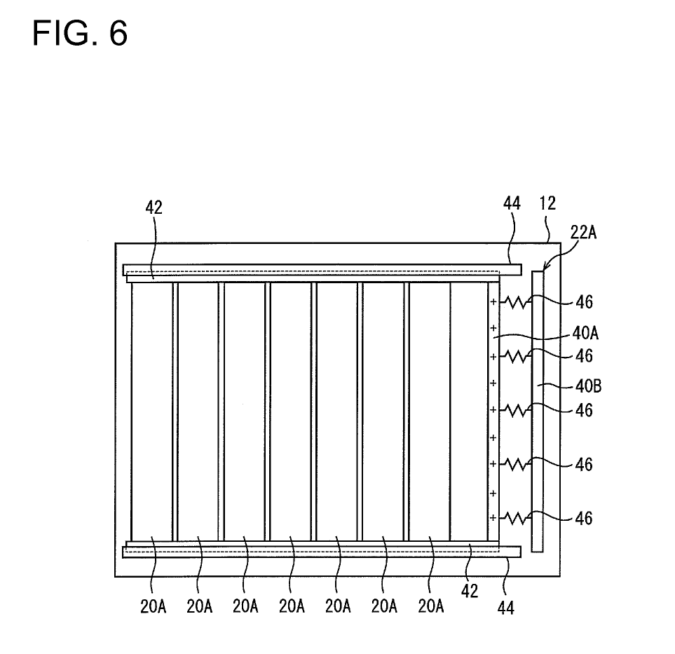

Next, a display device 10A according to Embodiment 2 of the present invention will be described with reference to FIGS. 5 and 6. The display device 10A includes an optical path changing device 14A instead of the optical path changing device 14. The second lenses and emission direction control device of the optical path changing device 14A differ from those used in the optical path changing device 14.

As shown in FIG. 5, in the present embodiment, the second lenses 20 are replaced by second lenses 20A. Each second lens 20A is a prism-shaped member having a prescribed cross-sectional shape. The cross-sectional shape of the second lenses 20A is symmetric around a reference line L2 that runs in the horizontal direction and around a reference line L3 that runs in the vertical direction. Each second lens 20A has two convex lens surfaces (a light-entering surface into which light enters and a light-exiting surface through which light exits). As a result, light that enters each second lens 20A is concentrated in a prescribed direction (that is, towards the center of the respective second lens 20A in the horizontal direction). The length of each second lens 20A in the horizontal direction is equal to two times the length of each inner lens surface 24 in the horizontal direction. In other words, the length of each second lens 20A in the horizontal direction is equal to two times the length of each pixel 16 in the horizontal direction.

As shown in FIG. 6, in the present embodiment, the emission direction control device 22 is replaced by an emission direction control device 22A. The emission direction control device 22A includes a pair of charging members 40A and 40B and a plurality of springs 46. The charging member 40A is fixed to a pair of supporting members 42. Each supporting member 42 runs in the horizontal direction relative to the display panel 12 (that is, the left-to-right direction in FIG. 6), and the pair of supporting members 42 connect together the plurality of second lenses 20A that are arranged side by side in the horizontal direction relative to the display panel 12. More specifically, one of the supporting members 42 supports the lengthwise ends of the second lenses 20A on one lengthwise side thereof, and the other supporting member 42 supports the lengthwise ends of the second lenses 20A on the other lengthwise side thereof (where the lengthwise direction is parallel to the vertical direction relative to the display panel 12 and runs in the vertical direction in FIG. 6). Each supporting member 42 is housed in a guide member 44 and can therefore move in the horizontal direction. The pair of charging members 40A and 40B are connected together by the springs 46. The charging member 40A is charged positively. The charging member 40B can be charged negatively or be put in a neutral state in which the charging member 40B is not charged positively or negatively. A driver circuit (not shown in the figure) can be used to achieve the charged state and the neutral state in the charging member 40B, for example. More specifically, a negative voltage can be applied to the charging member 40B to charge the charging member 40B negatively, and the charging member 40B can be grounded to achieve the neutral state in which the charging member 40B is not charged positively or negatively, for example.

In the emission direction control device 22A, negatively charging the charging member 40B creates an attractive force between the pair of charging members 40A and 40B and causes the charging member 40A to move towards the charging member 40B. Conversely, when the charging member 40B is in the neutral state, the charging member 40A moves away from the charging member 40B due to the energy stored in the springs 42. This causes the second lenses 22A to move back and forth in the horizontal direction.

<Operation of the Optical Path Changing Device>

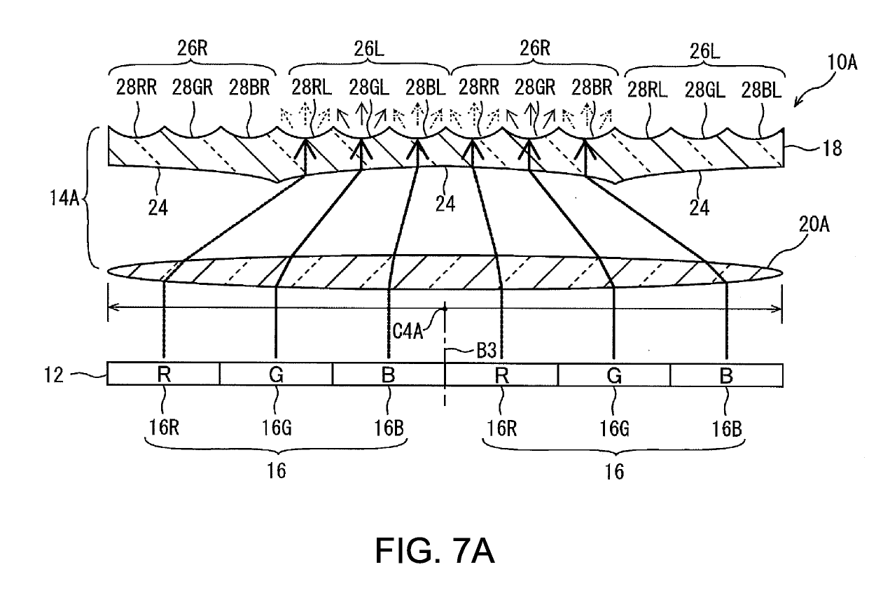

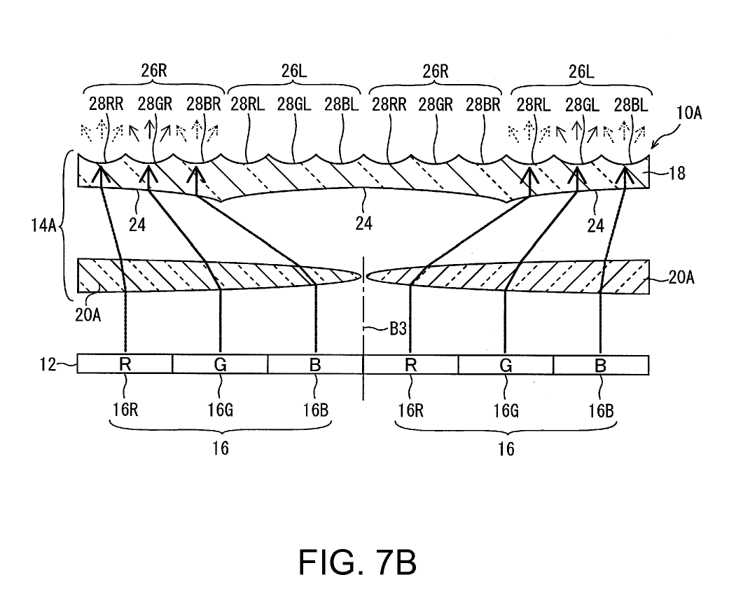

Next, operation of the optical path changing device 14A will be described with reference to FIGS. 7A and 7B. When the second lenses 20A are in the state shown in FIG. 3A (that is, when the centers C4A of each second lens 20A in the horizontal direction are positioned directly over the boundaries B3 between adjacent pixels 16), light emitted from the sub-pixels 16R, 16G, and 16B takes the paths described below.

Light emitted from the sub-pixel 16R of the right pixel 16 of two adjacent pixels 16 enters the respective second lens 20A and exits proceeding towards the inner lens surface 24 that overlaps with the abovementioned boundary B3 when the display panel 12 is viewed from the front side. The light emitted from the sub-pixel 16R then enters that inner lens surface 24 and exits from the first outer lens surface 28RR that overlaps with that inner lens surface 24 when the display panel 12 is viewed from the front side.

Light emitted from the sub-pixel 16G of the abovementioned right pixel 16 enters the same second lens 20A and exits proceeding towards the inner lens surface 24 that overlaps with the abovementioned boundary B3 when the display panel 12 is viewed from the front side. The light emitted from the sub-pixel 16G then enters that inner lens surface 24 and exits from the first outer lens surface 28GR that overlaps with that inner lens surface 24 when the display panel 12 is viewed from the front side.

Light emitted from the sub-pixel 16B of the abovementioned right pixel 16 enters the same second lens 20A and exits proceeding towards the inner lens surface 24 that overlaps with the abovementioned boundary B3 when the display panel 12 is viewed from the front side. The light emitted from the sub-pixel 16B then enters that inner lens surface 24 and exits from the first outer lens surface 28BR that overlaps with that inner lens surface 24 when the display panel 12 is viewed from the front side.

Light emitted from the sub-pixel 16R of the left pixel 16 of two adjacent pixels 16 enters the same second lens 20A and exits proceeding towards the inner lens surface 24 that overlaps with the abovementioned boundary B3 when the display panel 12 is viewed from the front side. The light emitted from the sub-pixel 16R then enters that inner lens surface 24 and exits from the first outer lens surface 28RL that overlaps with that inner lens surface 24 when the display panel 12 is viewed from the front side.

Light emitted from the sub-pixel 16G of the abovementioned left pixel 16 enters the same second lens 20A and exits proceeding towards the inner lens surface 24 that overlaps with the abovementioned boundary B3 when the display panel 12 is viewed from the front side. The light emitted from the sub-pixel 16G then enters that inner lens surface 24 and exits from the first outer lens surface 28GL that overlaps with that inner lens surface 24 when the display panel 12 is viewed from the front side.

Light emitted from the sub-pixel 16B of the abovementioned left pixel 16 enters the same second lens 20A and exits proceeding towards the inner lens surface 24 that overlaps with the abovementioned boundary B3 when the display panel 12 is viewed from the front side. The light emitted from the sub-pixel 16B then enters that inner lens surface 24 and exits from the first outer lens surface 28BL that overlaps with that inner lens surface 24 when the display panel 12 is viewed from the front side.

The second lenses 20A then move in the horizontal direction due to an attractive force between the pair of charging members 40A and 40B. This moves the second lenses 20A into the state shown in FIG. 7B. In the state shown in FIG. 7B, the second lenses 20A are moved by a distance equal to the length of one pixel in the horizontal direction from the state shown in FIG. 7A. In contrast with the state shown in FIG. 7A, in the state shown in FIG. 7B the boundaries B3 align with the boundaries between adjacent second lenses 20A. When the second lenses 20A are in the state shown in FIG. 7B, light emitted from the sub-pixels 16R, 16G, and 16B takes the paths described below.

Light emitted from the sub-pixel 16R of the right pixel 16 of the two adjacent pixels 16 enters the second lens 20A positioned to the right of the boundary B3 and exits proceeding towards the inner lens surface 24 to the right of the inner lens surface 24 that overlaps with the abovementioned boundary B3 when the display panel 12 is viewed from the front side. The light emitted from the sub-pixel 16R then enters that inner lens surface 24 and exits from the first outer lens surface 28RL that overlaps with that inner lens surface 24 when the display panel 12 is viewed from the front side.

Light emitted from the sub-pixel 16G of the abovementioned right pixel 16 enters the second lens 20A positioned to the right of the boundary B3 and exits proceeding towards the inner lens surface 24 to the right of the inner lens surface 24 that overlaps with the abovementioned boundary B3 when the display panel 12 is viewed from the front side. The light emitted from the sub-pixel 16G then enters that inner lens surface 24 and exits from the first outer lens surface 28GL that overlaps with that inner lens surface 24 when the display panel 12 is viewed from the front side.

Light emitted from the sub-pixel 16B of the abovementioned right pixel 16 enters the second lens 20A positioned to the right of the boundary B3 and exits proceeding towards the inner lens surface 24 to the right of the inner lens surface 24 that overlaps with the abovementioned boundary B3 when the display panel 12 is viewed from the front side. The light emitted from the sub-pixel 16B then enters that inner lens surface 24 and exits from the first outer lens surface 28BL that overlaps with that inner lens surface 24 when the display panel 12 is viewed from the front side.

Light emitted from the sub-pixel 16R of the left pixel 16 of the two adjacent pixels 16 enters the second lens 20A positioned to the left of the boundary B3 and exits proceeding towards the inner lens surface 24 to the left of the inner lens surface 24 that overlaps with the abovementioned boundary B3 when the display panel 12 is viewed from the front side. The light emitted from the sub-pixel 16R then enters that inner lens surface 24 and exits from the first outer lens surface 28RR that overlaps with that inner lens surface 24 when the display panel 12 is viewed from the front side.

Light emitted from the sub-pixel 16G of the abovementioned left pixel 16 enters the second lens 20A positioned to the left of the boundary B3 and exits proceeding towards the inner lens surface 24 to the left of the inner lens surface 24 that overlaps with the abovementioned boundary B3 when the display panel 12 is viewed from the front side. The light emitted from the sub-pixel 16G then enters that inner lens surface 24 and exits from the first outer lens surface 28GR that overlaps with that inner lens surface 24 when the display panel 12 is viewed from the front side.

Light emitted from the sub-pixel 16B of the abovementioned left pixel 16 enters the second lens 20A positioned to the left of the boundary B3 and exits proceeding towards the inner lens surface 24 to the left of the inner lens surface 24 that overlaps with the abovementioned boundary B3 when the display panel 12 is viewed from the front side. The light emitted from the sub-pixel 16B then enters that inner lens surface 24 and exits from the first outer lens surface 28BR that overlaps with that inner lens surface 24 when the display panel 12 is viewed from the front side.

As described above, as the second lenses 20A move, the light emitted from the sub-pixels 16R, 16G, and 16B exits alternately from the outer lens surfaces 26R and the outer lens surfaces 26L. Therefore, by switching the image displayed by the display panel 12 back and forth between an image formed from light emitted from the outer lens surfaces 26R and an image formed from light emitted from the outer lens surfaces 26L, the apparent number of pixels that the user perceives in the horizontal direction can be increased by a factor of two.

It should be noted that the timing with which each second lens 20A moves by a distance equal to the length of one pixel and the timing with which the image displayed by the display panel 12 is switched must be synchronized.

### Embodiment 3

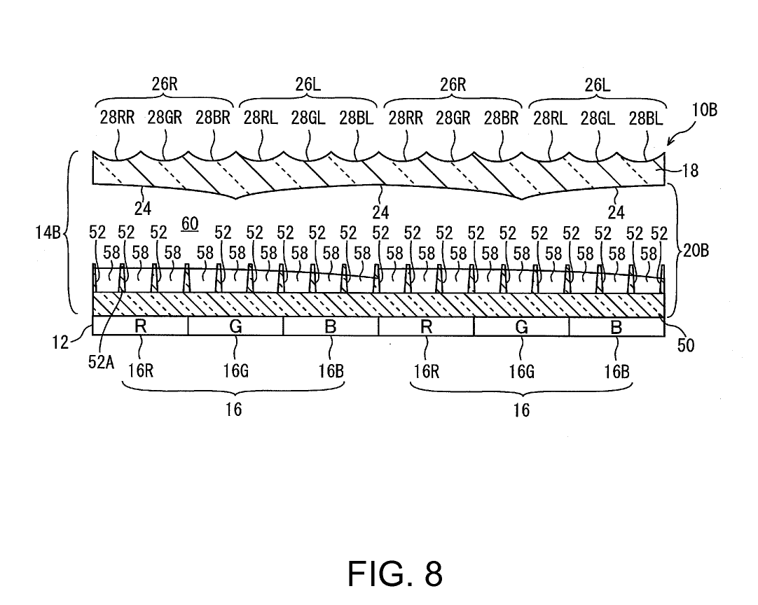

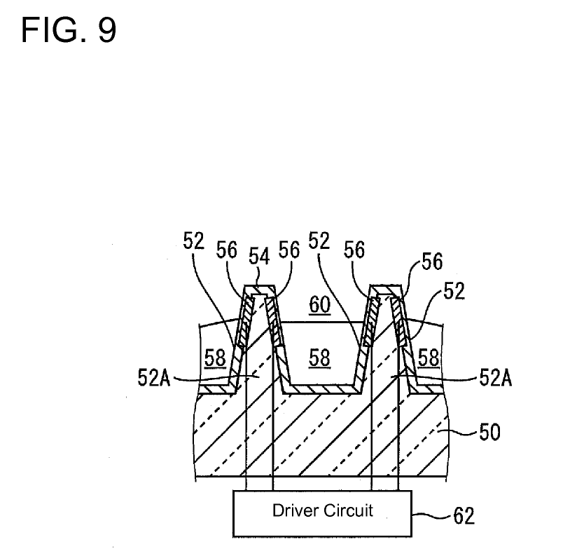

Next, a display device 10B according to Embodiment 3 of the present invention will be described with reference to FIGS. 8 and 9. The display device 10B includes an optical path changing device 14B instead of the optical path changing device 14. The second lenses and emission direction control device of the optical path changing device 14B differ from those used in the optical path changing device 14.

As shown in FIG. 8, in the present embodiment, the second lenses 20 are replaced by a second lens member 20B. As shown in FIGS. 8 and 9, the second lens member 20B includes a substrate 50, a plurality of trenches 52, a hydrophobic dielectric film 54, a plurality of electrodes 56, an oil film 58, and a liquid 60. The substrate 50 is arranged facing a first lens 18. The plurality of trenches 52 are formed side by side in the horizontal direction on the surface of the substrate 50 that faces the first lens 18. The hydrophobic dielectric film 54 is formed along the inner surfaces of the trenches 52. One electrode 56 is positioned on each wall in a pair of walls 52A of each trench 52, and the electrodes 56 are covered by the hydrophobic dielectric film 54. The oil film 58 is formed in contact with the hydrophobic dielectric film 54 and is housed within the trenches 52. The liquid 60 covers the oil film 58 and is separated therefrom. In the present embodiment, the liquid 60 is sealed inside the space between the hydrophobic dielectric film 54 and the first lens 18. The liquid 60 is water, for example.

As shown in FIG. 9, in the present embodiment, the emission direction control device 22 is replaced by an emission direction control device 22B. The emission direction control device 22B includes the electrodes 56 and a driver circuit 62. The driver circuit 62 applies voltages to the electrodes 56 and also changes the voltages applied to the electrodes 56. The interfaces between the oil film 54 and the liquid 60 are modified by applying different voltages to the right- and left-side electrodes 56 in each trench 52. In other words, in the present embodiment the interfaces between the oil film 54 and the liquid 60 are controlled using electro-wetting. Controlling the interfaces between the oil film 54 and the liquid 60 makes it possible to make the interfaces between the oil film 58 and the liquid 60 that overlap with one of the pixels 16 when the display panel 12 is viewed from the front side function as lens surfaces similar to those in Embodiment 1 (that is, similar to the first lens 18-side lens surfaces (light-exiting surfaces) of the second lenses 20). As a result, the direction of light emitted from the pixels 16 can be changed as that light exits the oil film 58. Therefore, like in Embodiment 1, the apparent number of pixels in the horizontal direction can be increased by a factor of two.

Embodiments of the present invention were described in detail above. However, these are only examples, and the present invention is not limited in any way by the embodiments described above.

For example, the pixels in Embodiments 1 and 2 may further include sub-pixels that emit yellow light, or the pixels may be monochrome pixels.

1. A display device, comprising:
a display panel including a plurality of pixels formed side by side in a prescribed direction; and
an optical path changing device that is arranged closer to a viewer's side than the display panel,
wherein the optical path changing device comprises:
a first lens; and
an optical path controller between the display panel and the first lens to control optical paths of respective light rays from the plurality of pixels in the display panel,
wherein the first lends includes:
a light receiving inner surface having a plurality of inner lens surfaces formed side by side in the prescribed direction on a display panel side of the first lens; and
a light exit outer surface having a plurality of outer lens surfaces that are formed side by side in the prescribed direction on the viewer's side, a prescribed number of the outer lens surfaces among the plurality of outer lens surfaces being corresponding to and overlapping each of the inner lens surfaces when the display device is viewed from the viewer's side,
wherein the inner lens surfaces and the outer lens surfaces of the first lens are configured such that light from the display panel that has entered a prescribed portion of the inner lens surface in a prescribed incident angle exits from a corresponding one of the outer lens surfaces to reach the viewer, and
wherein the optical path controller sets the optical paths of the respective light rays from the plurality of pixels for each display frame such that in a first display frame, the respective light rays from the plurality of pixels are directed to prescribed portions of the light receiving inner surface of the first lens so that the respective light rays are emitted from only a subgroup of the plurality of outer lens surfaces, and such that in a second display frame that is subsequent to the first display frame, the respective light rays from the plurality of pixels are directed to prescribed portions of the light receiving inner surface that are different from the prescribed portions for said first display frame so that the respective light rays are emitted from only the rest of the plurality of outer lens surfaces of the first lens.

2. The display device according to claim 6,
wherein the second lenses are configured to be rotatable between a first position and a second position differing from the first position, and
wherein a direction in which light from the pixels is focused when the second lenses are in the first position differs from a direction in which light from the pixels is focused when the second lenses are in the second position.

3. The display device according to claim 6,
wherein the second lenses are configured so as to be moveable laterally between a first position and a second position that differs from the first position, and
wherein a direction in which light from the pixels is focused when the second lenses are in the first position differs from a direction in which light from the pixels is focused when the second lenses are in the second position.

4. The display device according to claim 1,
wherein the optical path controller comprises:
a substrate facing the first lens;
a plurality of trenches arranged side by side in the prescribed direction on a surface of the substrate facing the first lens;
a hydrophobic dielectric film formed along inner surfaces of the trenches;
electrodes that are covered by the hydrophobic dielectric film, one of the electrodes being arranged on each wall among a pair of walls of each trench;
an oil film housed inside the trenches and arranged in contact with the hydrophobic dielectric film; and
a liquid that covers the oil film and is separated therefrom,
wherein the optical path controller is configured to control the optical paths of the respective light rays from the plurality of pixels in the display panel in accordance with voltages applied to the electrodes.

5. The display device according to claim 1,
wherein the pixels include a plurality of pixels that respectively emit light of different colors.

6. The display device according to claim 1, wherein the optical path controller comprises:
a plurality of second lenses arranged side by side in the prescribed direction and disposed closer to the display panel than the first lens; and
an emission direction control device that controls the plurality of second lenses so as to control the optical paths of respective light rays reaching the first lens.
